(19) United States
(12) Patent Application Publication
(10) Pub. No.: US 2018/0216540 A1
(43) Pub. Date: Aug. 2, 2018

(54) Turbocharged Engine Assembly Having Two Exhaust Ducts Provided With A Control Valve

(71) Applicants: PSA AUTOMOBILES S.A., Poissy (FR); BorgWarner Inc., Auburn Hills, MI (US)

(72) Inventors: Arnaud Dupuis, Paris (FR); Diego Rafael Veiga Pagliari, Paris (FR); David Roth, Groton, NY (US)

(21) Appl. No.: 15/575,289

(22) PCT Filed: May 27, 2016
(86) PCT No.: PCT/FR2016/051274

§ 371 Date: Apr. 20, 2018

(30) Foreign Application Priority Data
Jun. 2, 2015 (FR) 1554984
Jun. 2, 2015 (FR) 1554985

(51) Int. Cl. F02D 13/02; F02B 37/18; F02D 41/00

(52) U.S. Cl. CPC F02D 13/0257; F02B 37/183; F02M 26/07; F02D 41/0007; F02D 13/0219

(57) ABSTRACT

The invention concerns an engine assembly (1) comprising a turbocharged engine with at least one cylinder having first and second outlet passages, the first passage being connected to a first manifold (5) while the second passage is connected to a second manifold (7) of an exhaust system comprising a first duct (4) extending from the first manifold (5) and a second duct (6) extending from the second manifold (7). The turbine (2) is provided with a wheel housed in a main pressure-relieving passage, the first duct (4) opening into the main passage. The first outlet passage is provided with means (20) for actively closing during the exhaust phase of the engine and the second duct (6) opens into at least one internal branching portion (8) of the turbine (2), bypassing the main pressure-relieving passage.

### CROSS-REFERENCE TO RELATED APPLICATIONS

This application derives and claims priority from International Application PCT/FR2016/051274, filed May 27, 2016, and published under International Publication Number WO2016/192597, which derives priority from French applications Serial No. 1554984 and Serial No. 1554985, both filed Jun. 2, 2015, and which are hereby incorporated by reference.

### BACKGROUND

The present invention relates to a turbocharged engine assembly having two exhaust ducts provided with means to keep at least one engine outlet passage closed during the exhaust phase of the gases generated inside the engine during combustion.

Such an engine assembly comprises an internal combustion engine with at least one cylinder comprising two exhaust gas outlet passages closed sequentially by a respective exhaust valve. The assembly also comprises a turbocharger and an exhaust system comprising two exhaust ducts. Such an engine assembly can advantageously but not exclusively be a four-stroke gas engine.

FIG. 1 shows a supercharged gas engine assembly according to the closest state of the art described in particular in document WO-A-2009/105463. Such an engine assembly is known as a Valve Event Modulated Boost (VEMB) engine. This type of engine assembly will be described after the general presentation of a conventional supercharged engine and an engine equipped with an exhaust gas recirculation line at the engine intake, also called an EGR line.

Referring to FIG. 1 for some of the parts illustrated in this Figure, a combustion engine comprises a cylinder block equipped with at least one cylinder, advantageously several cylinders, and an air intake inlet or air intake manifold for the air/gas mixture in each cylinder as well as an outlet for the exhaust gas resulting from the combustion of the mixture in each cylinder. The engine outlet is linked to an exhaust manifold 5 supplying an exhaust duct 4, 9 removing the exhaust gases to the outside.

The fact that two exhaust manifolds 5, 7, each with an associated exhaust duct 4, 6 are shown for the engine assembly in FIG. 1 is not applicable to every turbocharged engine assembly, such an engine usually comprising only one manifold 5 and only one exhaust pipe 4, 9 which passes through a turbine 2.

The turbocharged engine comprises a turbine 2 and a compressor 3. The turbine 2 is arranged downstream of the exhaust manifold 5 in the exhaust duct 4 while the compressor 3 is arranged upstream of the engine air intake manifold. The turbine 2 comprises a turbine impeller recovering at least partially the kinetic energy created in the exhaust gases passing through it, the rotating element as an impeller of the turbine being rotated by the exhaust gases leaving the exhaust manifold. The turbine 2 drives the compressor 3 by being secured to it by a shaft. The compressor 3 is passed through by the fresh air intended to supply the engine with air, which the compressor 3 compresses.

At the outlet of the compressor 3, this air is called supercharged air and is conveyed by the air supply line towards a supercharged air cooler 25 to cool the air exiting the compressor 3. On this line a throttle valve 26 is also positioned, regulating the flow of air into the air intake manifold of the engine forming the engine air inlet.

On the exhaust side of the engine assembly 1, at the outlet of the turbine 2, the exhaust gases removed from the engine penetrate into the exhaust duct 9 of the motor vehicle after having passed through the turbine, then pass through a means for exhaust gas decontamination 10, for example one or more catalytic converters, specifically a means of oxidation, of reduction, or a three-way means associated with a particle filter. A Selective Catalytic Reduction system or SCR system can also be provided in the exhaust pipe 9.

It is also common to provide an engine assembly with an exhaust gas recirculation line at the engine's air intake, also called an EGR line, said line being referenced as 11 in FIG. 1. It is known for positive-ignition and compression-ignition combustion engines to recirculate the exhaust gases towards the air intake of the combustion engine in order to reduce nitrogen oxide emissions. Such a system is also known by the acronym EGR, which stands for Exhaust Gas Recirculation.

An EGR line 11 has a branch 12 on the exhaust duct to draw off some of the exhaust gases from the duct, as well to serve as a coolant 23 for the exhaust gases passing through this line 11, these gases at that stage being very hot. The EGR line 11 opens into the air intake upstream of the compressor 3 that it supplies. A valve 24 called an EGR valve is fitted to the EGR line 11, advantageously downstream of the cooler 23 in order to open or close the circulation of gases towards the intake.

For any type of EDR line 11, the recirculation of exhaust gases towards the air intake of the combustion engine improves the thermodynamic performance of the engine due to the reduction of heat transfer, which is a result of the reintroduction of recycled gases via the EGR line 11 into the intake manifold. Such recirculation can also reduce enrichment linked to the exhaust temperature and reduce pumping losses when the engine is associated with a turbocharger.

Efforts to reduce pumping losses have failed to achieve completely satisfactory results and pumping phenomena still persist in the turbine 2. It was proposed to use a discharge valve inside the turbine. An exhaust system was then proposed for a valve event modulated boost engine assembly with two exhaust ducts as shown in FIG. 1.

The combustion engine forming part of the valve event modulated boost engine assembly 1 has at least one cylinder, with three cylinders shown in FIG. 1. Each engine cylinder is provided with an intake valve and two exhaust valves. These exhaust valves are associated respectively with a first or a second outlet passage in a cylinder and selectively open and close their associated passage.

The same principle applies to the intake valve associated with an inlet passage in each cylinder. The two outlet passages of each cylinder that are closed and opened sequentially by their associated exhaust valve open into a different exhaust manifold 5, 7 each supplying a dedicated exhaust duct 4, 6, the two exhaust ducts 4, 6 not following the same route, as will be later described in detail. The first outlet passage of each cylinder is linked to the first manifold 5 and the second outlet passage is linked to the second manifold 7.

Said valve event modulated boost engine assembly 1 therefore comprises an exhaust duct 4 through the turbine 2 leading from a first exhaust manifold 5 and a second discharge duct 6 leading from a second exhaust manifold 7, the exhaust manifolds 5, 7 each being connected respectively to one of the two series of first or second outlet passages equipped with their exhaust valves provided for each cylinder.

The first duct 4 leads to an inlet face of the turbine 2 of the turbocharger being extended by a main expansion passage inside the turbine 2 housing a turbine impeller therein, allowing the kinetic energy contained in the exhaust gases passing through it to be recovered. The second duct 6 bypasses the turbine 2 without penetrating therein but joins further downstream of the turbine a third duct 9, outside the turbine 2 for the removal of the exhaust gases from the main expansion passage having exchanged energy with the turbine impeller so that there is only one single exhaust duct 9 passing through the decontamination elements 10 located at the end of the exhaust system. This means that, in such a valve event modulated boost engine according to the state of the art, the second duct 6 has no extension penetrating the turbine 2.

The function of the first duct 4 called the exhaust duct which extends through the turbine, is to allow a first flow of exhaust gas to pass through the turbine 2 and through its rotating energy recovery device, in the form of an impeller, in order to provide power for the compressor 3. The function of the second duct 6 called the discharge duct and supplied by a second exhaust manifold 7, different and independent from the first exhaust manifold 5 of the first duct 4, is to allow a second flow of exhaust gas independent and different from the first flow to bypass the turbine 2 and specifically its impeller and thus to discharge the turbine 2 of the total flow of exhaust gas while reducing the flow of exhaust gas passing through it by subtracting the second flow from the total flow.

This allows the power of the turbine to be discharged and/or controlled, as would in the conventional operating condition of regulation of the engine load, a discharge valve, a device previously known in the state of the art for a turbocharged engine. This specifically avoids the pumping phenomenon of the compressor by involving a return of the hot gases to the intake air inlet.

For a conventional turbocharged engine, a discharge valve that can be internal or external to the turbine serves to limit the pressure of the exhaust gases on the turbocharger turbine impeller by opening a bypass for the exhaust gases so that they no longer pass through the turbine and its impeller. A limitation of the turbine impeller speed is thus achieved, which also limits the speed of rotation of the impeller provided in the compressor since it is secured to the turbine impeller, thus also limiting the compression of the intake air.

A discharge valve associated with a turbine to regulate the flow of exhaust gas passing through it is no longer necessary with a valve event modulated boost engine having two exhaust pipes each leading from a respective exhaust manifold.

Thus, such an engine assembly improves the efficiency of the engine cycle by reducing engine pumping during the exhaust phase of a four-stroke cycle, which has a favorable impact on engine consumption. A better control of the energy recovered by the turbine is thus achieved, which results in better management of engine load.

On each cylinder, however, the opening of the exhaust valve indirectly linked to the second duct 6 very often occurs after the opening of the exhaust valve of the same cylinder linked to the first duct 4 and always during the exhaust phase of the four-stroke cycle of the engine, even on the most delayed timing of the opening of the exhaust valve linked to the second duct 6. A period of time thus elapses during which both exhaust valves are open at the same time, which means that the second discharge duct 6 is always operational, whereas this can be unfavorable in certain conditions of operation of the engine assembly 1.

This is disadvantageous, for example, at operating points of the engine assembly 1 corresponding to operating points of a turbocharger with a closed discharge valve, specifically points at low engine speed and full load, for which points, in the state of the art relating to a turbocharger with a discharge valve, the closing of the discharge valve in a conventional turbine is necessary in order to maximize the power of the turbine 2.

Thus, the second discharge duct 6 of the exhaust system in a valve event modulated boost engine may not be closed, whereas it would be advantageous for it to be in order to make the entire flow of exhaust gas pass through the turbine 2 via its rotary element, and through the first so-called exhaust duct 4 via the turbine.

Thus, the permanent opening of the second discharge duct 6 reduces the power available to the turbine 2, due to the smaller flow of gas passing over the impeller of the turbine 2, which translates into a degradation of the engine's response, particularly in transient conditions and at steady speed. Such permanent opening of the second duct 6 is thus not preferred and should be remedied in certain operating conditions of the engine assembly 1.

Conversely, the same applies to closure of the first duct 4 passing through the turbine 2. It would be advantageous if this first exhaust duct 4 through the turbine could for example be closed or have a reduced flow in certain engine operating conditions, particularly but not limited to, when it is necessary to heat the decontamination elements 10 downstream of the turbine 2 in the exhaust system that must reach a minimum temperature to ensure optimum decontamination.

Document FR-A-2 835 882 discloses an engine assembly with a system having two exhaust ducts linked respectively to a series of first and second exhaust valves, each engine cylinder having a first and second exhaust valve closing one of the two outlet passages that each cylinder comprises. This document discloses means for closing at least one series of the two valves depending on the prevailing operating conditions of the engine.

By contrast, this document does not describe the problem posed by closing the first flow passing through the first pipe and then through the main expansion passage housing the turbine impeller and its impact on the adjustment of the engine's intake and exhaust that are consequently disrupted.

Consequently, the problem underlying the invention, in said valve event modulated boost turbocharged engine assembly with two exhaust ducts, is to be able to control the flow in said exhaust duct through the turbine while exchanging energy with the turbine directly at the engine outlet on the first outlet passage of the two passages that have the cylinder or each cylinder of the engine, in a simple and efficient way avoiding the phenomena of poor engine operation that may occur while keeping this first outlet passage closed during the exhaust phase.

### SUMMARY

In order to achieve this objective, a method is provided according to the invention to control an exhaust of an internal combustion engine assembly of a motor vehicle having a turbocharger comprising a turbine and a compressor, and an exhaust system, the engine having at least one cylinder housing a piston linked to a rotating crankshaft and movable inside said at least one cylinder between a most internal position called Top Dead Center and a least internal position called Bottom Dead Center. Said piston comprising at least one cylinder having a first and second outlet passage opening into the exhaust system for a removal of the exhaust gases resulting from the combustion in the engine and an intake passage, the first and second outlet passage being equipped respectively with a first and a second exhaust valve and the intake passage being equipped with an intake valve, the exhaust valves opening their passage between Bottom Dead Center and Top Dead Center during an exhaust phase and the intake valve opening its passage between Top Dead Center and Bottom Dead Center according to an angle of rotation of the crankshaft with, for each valve, a predetermined opening advance and closing delay in relation to said Dead Centers. The exhaust having two gas exhaust flows exiting the engine, a first exhaust flow coming from the first outlet passage of said at least one cylinder passing through the turbine housing an impeller for the partial recovery of an energy contained in the exhaust gases inside the turbine and a second so-called discharge flow coming from the second outlet passage joining the first flow downstream of the impeller while bypassing it, such that at least the first flow is interrupted temporarily in the exhaust system when a minimum temperature of the exhaust gases is required or when the operating conditions of the engine bring about a turbocharger pumping risk, suspensive operating conditions of the interruption of the first flow being an increase in engine load requiring a use of the turbocharger and such that, while keeping the first outlet passage closed, during the exhaust phase, at least the opening advance of the second exhaust valve and the opening advance of the intake valve of said at least one cylinder are modified.

The technical effect is to achieve a modulation of at least the first flow directly at the engine outlet during exhaust phases, which gives greater responsiveness to the control method than a regulation by a valve arranged on the first duct to interrupt the first flow. Moreover, the engine operating conditions, both during intake and exhaust, are adapted to the stoppage of the first flow unlike the state of the art which fails to take into consideration the impact of the stoppage of the first flow on the operation of the engine.

For example, without limitation, the first outlet passage of said at least one cylinder is kept closed during the exhaust phase, on the one hand, when there is no ongoing demand for engine power, which would require the operation of the turbine in energy recovery mode and thus its being supplied by the first flow and, on the other hand, when a need to discharge the turbine or a need to heat the decontamination elements present in the exhaust system exists, heating being performed by the second flow which is hotter than the first flow having lost calories during contact with the turbine impeller.

Advantageously, the opening advance position of the second exhaust valve of said at least one cylinder dedicated to the second flow is adjusted to a position at least equal to or above Bottom Dead Center in combination with an opening advance position of the intake valve at least equal to or above the closing delay position of the second exhaust valve with a valve width law for the second exhaust valve between the opening advance position of the second exhaust valve and the closing delay of the second exhaust valve which is no less than 140° of the engine's crankshaft angle.

Advantageously, the engine's operating conditions, for closing the first flow and if necessary the second flow, are evaluated by monitoring at least one engine operating parameter, said at least one operating parameter being selected from the following parameters considered individually or in combination: engine speed, time elapsed after start-up, exhaust gas temperature, engine temperature, one or more parameters representative of the engine load such as the air intake pressure at the engine's inlet or a demand for power issued by the vehicle's driver.

Advantageously, the interruption of the first flow is performed:

in conditions after engine start-up for which the prevailing temperature values of the exhaust gases at the end of the exhaust system are detected as being below or estimated as being below a predetermined exhaust gas temperature value with the monitored operating parameters being the detected exhaust gas temperature or the engine temperature and the average engine speed over a period elapsed after start-up for an estimation of the exhaust gas temperature, the interruption of the first flow ceasing when the detected or estimated exhaust gas temperature exceeds the predetermined exhaust gas temperature value or when one or more of the parameters representative of the engine load monitored in order to evaluate the suspensive operating conditions indicate a need for the operation of the turbocharger with a required engine air intake pressure value above atmospheric pressure, or

when the engine speed and one or more parameters representative of the engine load are below predetermined respective values not requiring the use of the turbocharger, the interruption of the first flow ceasing when one or more parameters representative of the engine load monitored in order to evaluate the suspensive operating conditions indicate a need for operation of the turbocharger with a required engine air intake pressure value higher than atmospheric pressure.

The invention also concerns an engine assembly comprising an internal combustion engine with at least one cylinder, a turbocharger comprising a turbine and a compressor, and an exhaust system for implementing such a method, the engine comprising at least one cylinder having a first and a second outlet passage for a removal of the exhaust gases resulting from the combustion in the engine, the first and second outlet passages being provided respectively with a first and a second exhaust valve, the first outlet passage being connected to a first manifold while the second outlet passage is connected to a second manifold, the exhaust system comprising a first exhaust duct through the turbine leading from the first exhaust manifold and a second discharge duct leading from the second exhaust manifold for the removal of the gases resulting from the combustion in the engine during an exhaust phase, the turbine having a main expansion passage in which is housed a turbine impeller, the first pipe opening into the main expansion passage at the turbine inlet, characterized in that the first outlet passage of said at least one cylinder is provided with active means to keep closed during the engine's exhaust phase and in that the second pipe opens into the turbine in at least one bypass portion inside the turbine bypassing the main expansion passage.

Advantageously, the second outlet passage of said at least one cylinder is provided with active means to keep closed during the engine's exhaust phase, the closing means of one of the outlet passages being independent of the closing means of the other of the two outlet passages of said at least one cylinder.

Advantageously, the closing means are means for keeping the associated exhaust valve in a deactivated position in which the exhaust valve blocks its associated outlet passage of said at least one cylinder during the exhaust phase.

Advantageously, the closing means are in the form of a cam displacement system with a disengageable tappet or disengageable follower or a sliding cam, the tappet or follower being associated with a hydraulic or electrical control, or in the form of an electromagnetic valve or a pneumatic valve.

Advantageously, the exhaust system comprises a third duct outside the turbine coming out of the turbine, the third duct removing the exhaust gases from the main expansion passage and from said at least one bypass portion outside the turbine, the third pipe comprising decontamination elements for the exhaust gases passing through it.

Another aim of the invention is to solve the problem, in addition to the one described above, of being able to control selectively the flow in the two ducts of a valve event modulated boost engine assembly with two exhaust pipes in a simple and effective manner directly in each of the two exhaust ducts depending on the operating conditions then prevailing in the engine assembly.

In order to achieve this aim, a method is provided to control an internal combustion engine assembly of a motor vehicle having a turbocharger comprising a turbine and a compressor, and an exhaust system having two flows of exhaust gases at an outlet of the engine, a first flow passing through the turbine housing an impeller for the partial recovery of an energy contained in the exhaust gases and a second flow joining the first flow downstream of the impeller while bypassing it, so that the two flows are selectively temporarily interrupted. On the one hand, the first flow being interrupted in the exhaust system when a minimum exhaust gas temperature is required or when the engine's operating conditions cause a risk of pumping of the turbocharger, suspensive operating conditions of the interruption of the first flow being an increase of an engine load requiring a use of the turbocharger and, on the other, the second flow being interrupted in the event of an increase of an engine load requiring a use of a turbocharger, suspensive operating conditions of the interruption of the second flow being a risk of pumping of the turbocharger, the engine's operating conditions being assessed by monitoring at least one engine operating parameter selected from the following parameters considered individually or in combination: engine speed, time elapsed after start-up, exhaust gas temperature, engine temperature, one or more parameters representative of the engine load such as the air intake pressure at the engine's inlet or a demand for power issued by the vehicle's driver.

This method can advantageously be combined with the control method described above, or be applied independently thereof.

The technical effect is to obtain a better control of a valve event modulated boost engine assembly having an exhaust system with two ducts, the interruption occurring in the exhaust system, i.e. in the exhaust ducts, channeling the first and second flows respectively and not directly at the engine's outlet, which is easier to achieve.

When an engine power demand is required, only the first flow passes through the entire exhaust system with interruption of the second flow and when a discharge of the turbine is necessary or when a heating demand of the decontamination elements in the exhaust system is required, the first flow is reduced or even interrupted, and the exhaust flow passes mainly as a second flow into the second so-called discharge pipe of the system.

In a first embodiment, the first flow is interrupted:

in conditions after engine start-up for which the prevailing temperature values of the exhaust gases at the end of the exhaust system are detected as being below or estimated as being below a predetermined exhaust gas temperature value with the monitored operating parameters being the detected exhaust gas temperature or the engine temperature and the average engine speed over a period elapsed after start-up for an estimation of the exhaust gas temperature, the interruption of the first flow ceasing when the detected or estimated exhaust gas temperature exceeds the predetermined exhaust gas temperature value or when one or more of the parameters representative of the engine load monitored in order to evaluate the suspensive operating conditions indicate a need for the operation of the turbocharger with a required engine air intake pressure value above atmospheric pressure, or

when the engine speed and one or more parameters representative of the engine load are below predetermined respective values not requiring the use of the turbocharger with an engine air intake pressure value below or equal to atmospheric pressure, the interruption of the first flow ceasing when one or more parameters representative of the engine load monitored in order to evaluate the suspensive operating conditions indicate a need for operation of the turbocharger with a required engine air intake pressure value higher than atmospheric pressure.

Advantageously, a treatment will be performed to decontaminate the exhaust gases of the first and second flows after the first flow is joined by the second flow at the end of the exhaust system, said treatment requiring a minimum exhaust gas decontamination treatment temperature in order to operate, said minimum exhaust gas decontamination treatment temperature serving as a predetermined temperature value of the exhaust gases at the end of the exhaust system for the interruption of the first flow.

In a second embodiment, the flow is interrupted:

when the engine speed is below a predetermined speed value and when one or more of the parameters representative of the engine load exceed a predetermined engine load value, or

for transient engine speeds with one or more parameters representative of the engine load higher than a predetermined engine load value, the predetermined engine load value in both cases requiring the use of the turbocharger with a required engine air intake pressure value higher than atmospheric pressure.

The invention also relates to an engine assembly having an internal combustion engine, a turbocharger comprising a turbine and a compressor, and an exhaust system for implementing such a method, the engine comprising at least one cylinder having two outlet passages for a removal of the exhaust gases resulting from the combustion in the engine, the first outlet passage being linked to a first manifold while the second outlet passage is linked to a second manifold for a removal of the exhaust gases resulting from the combustion in the engine, the exhaust system comprising a first said exhaust pipe through the turbine leading from the first exhaust manifold and a second so-called discharge pipe leading from the second exhaust manifold for channeling the exhaust gases through the first and second pipes of the turbine being provided with a casing having within it a main expansion passage in which is housed a turbine impeller and the first pipe opening into the main expansion passage through an inlet face of the casing, the second pipe bypassing the turbine impeller, characterized in that the system comprises interruption means of the flow of exhaust gas in the first and second pipes, the flow interruption means of one of the two pipes being independent of the flow interruption means of the other one of the two pipes.

A better control of the exhaust is thus obtained by using simple means. Advantageously, the flow interruption means are in the form of a regulation valve associated with the first and second pipe respectively.

Advantageously, each valve is a control valve of the type turbocharger discharge valve, throttle valve, engine valve, with a diaphragm or ball, this valve being provided with its own specific electrical, pneumatic or hydraulic actuator.

Advantageously, the second duct opens through the inlet face of the casing into at least one bypass portion inside the casing bypassing the main expansion passage, the main expansion passage and at least one bypass portion joining at an outlet face of the casing, the exhaust system comprising a third duct outside the turbine while being linked to the outlet face of the turbine casing in order to remove the exhaust gases from the turbine.

Advantageously, the flow interruption means are in the form of a regulation valve positioned for each pipe either on the exhaust manifold associated with said pipe, or in the turbine casing on the main expansion passage and, when present, on said at least one bypass portion.

Advantageously, when the regulation valve is positioned between its respective exhaust manifold and the turbine, one face of the turbine opposite the first and second exhaust manifolds comprises a flange fixed to a flange on each exhaust manifold, the regulation valve of each of the first and second pipes being positioned between the flange of the respective exhaust manifold and the flange of the turbine.

The subject matter of the invention also concerns the motor vehicle comprising the engine assembly described above.

### DESCRIPTION OF THE DRAWINGS

Further features, aims and advantages of the present invention will emerge from the following detailed description and with regard to the accompanying drawings, given purely by way of non-limiting examples, in which:

FIG. 1 is a schematic representation of a valve event modulated boost engine assembly comprising an exhaust system with two exhaust ducts based on the closest state of the art,

FIG. 1a is a schematic representation of a valve event modulated boost engine assembly comprising an exhaust system with two exhaust ducts with each pipe equipped with a regulation valve according to a first embodiment of the present invention,

FIG. 2 is a schematic representation of an engine assembly comprising an exhaust system with two exhaust ducts according to an embodiment of the present invention, the turbine being passed through by the extension of the two pipes and the engine comprising means to keep closed the first passage of the two outlet passages of the one or more cylinders,

FIG. 3 is a schematic representation of a cycle of an internal combustion engine showing the different stages of the cycle and the succession of exhaust and intake phases with the opening of an exhaust valve and an intake valve,

FIG. 4 is a schematic representation of a valve lift with opening advance and closing delay of the valve,

FIG. 5 shows three examples of opening advance and closing delay of the intake and exhaust valves, the example at the bottom of this Figure being in accordance with the method of controlling an exhaust according to the present invention,

FIG. 6 shows three curves as a function of time of the Mean Effective Pressure, or MEP, for respectively a conventional turbocharged engine, a valve event modulated boost engine, these two curves being obtained by an engine assembly according to each of the two states of the art respectively, and one curve being obtained for an engine assembly according to the present invention,

FIG. 7 shows engine torque as a function of engine speed for a circulation in the second activated and deactivated pipe respectively, for low engine speeds, showing a gain in engine torque, resulting from the deactivation of the second duct, that can be obtained using the engine assembly according to the present invention,

FIG. 8 shows two temperature increase curves over time at the end of the exhaust system for a valve event modulated boost engine assembly according to the state of the art and for an engine assembly according to the present invention respectively.

### DETAILED DESCRIPTION

It should be noted that the Figures are given by way of example and are non-limiting with regards to the invention. They constitute schematic representations of principle intended to facilitate an understanding of the invention and are not necessarily to the scale of practical applications. In particular, the dimensions of the different elements shown are not representative of reality.

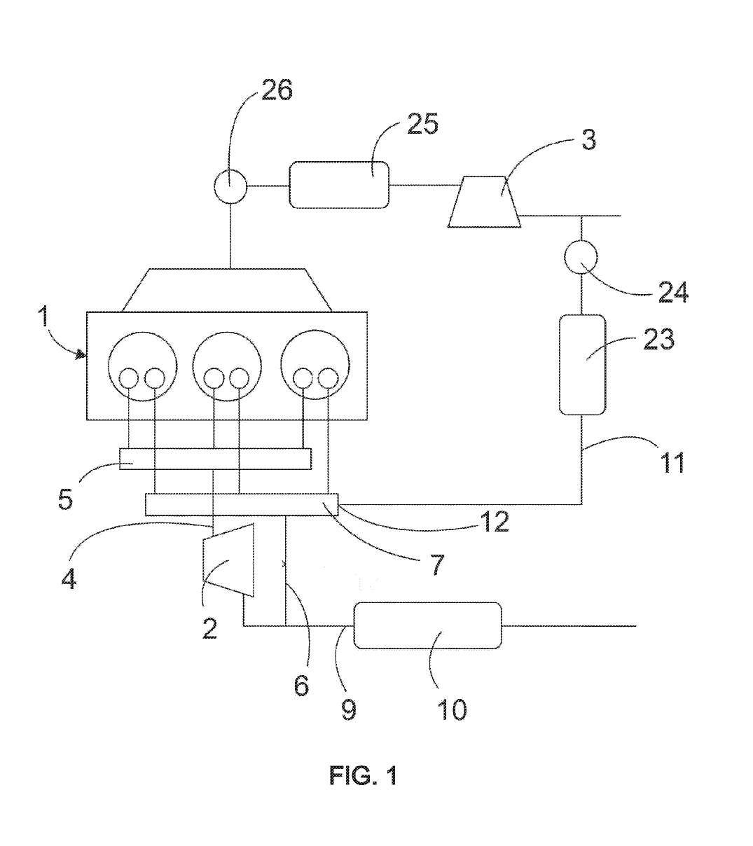

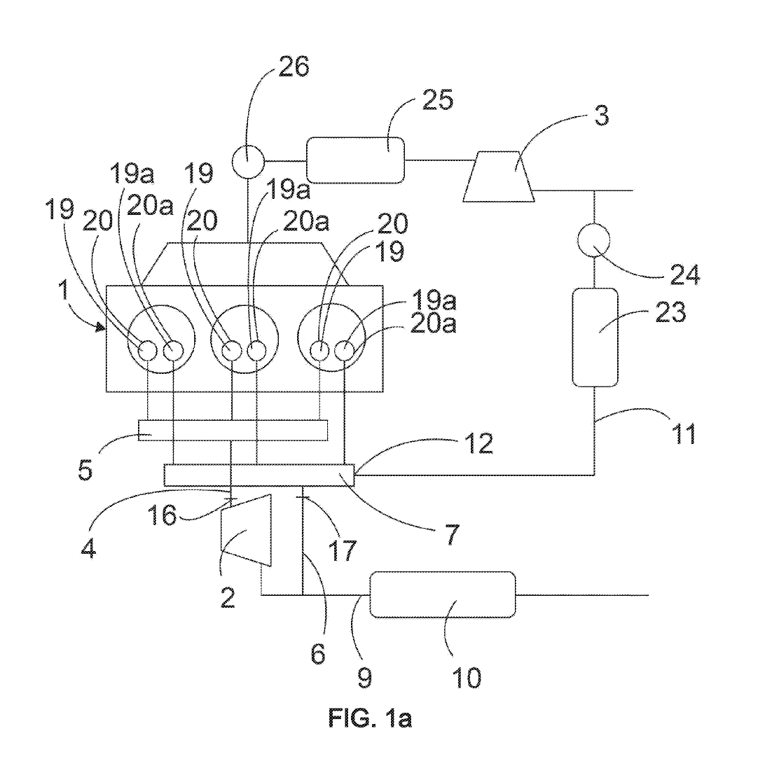

FIGS. 1 to 4 concern the first aspect of the invention. FIGS. 1a-8 concerns the second aspect of the invention.

In what follows, the words downstream and upstream are to be understood in relation to the direction of flow of the exhaust gases outside the engine or back towards the engine intake for the recirculation line, an element in the exhaust system downstream of the engine being further away from the engine than another element located upstream of the element. That which is called the engine assembly comprises the combustion engine as well as its auxiliaries for the intake of air into the engine and for the exhaust of gases out of the engine, a turbocharger also forming part of the engine assembly, the turbine being included in the exhaust system of the engine assembly.

FIG. 1 has already been described in the introductory part of this application.

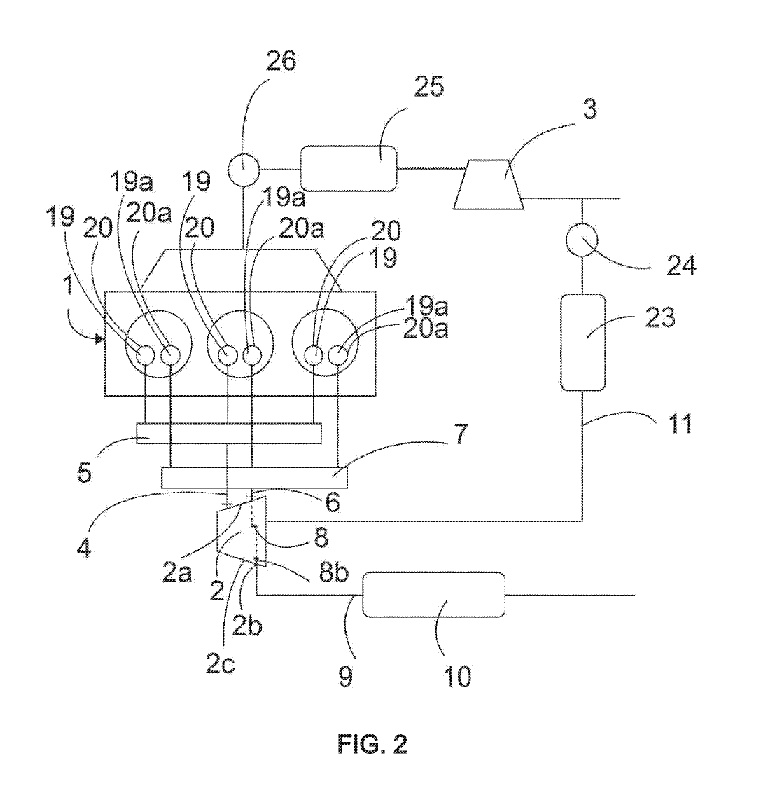

With reference to FIGS. 1a and 2, which represent two alternative embodiments according to the present invention, the latter relates to a valve event modulated boost internal combustion engine assembly 1 of a motor vehicle.

The engine comprises at least one cylinder housing a piston linked to a rotating crankshaft which is moveable inside said piston and at least one cylinder between a most internal position, called Top Dead Center, and a least internal position, called Bottom Dead Center. Top Dead Center is the highest point that the piston can reach in the cylinder and, conversely, Bottom Dead Center is the lowest point that the piston can reach, the stroke being the length of travel between Top Dead Center and Bottom Dead Center.

In FIG. 2, three cylinders are shown, without limitation. Each cylinder has first and second outlet passage opening into the exhaust system for a removal of the exhaust gases resulting from the combustion in the engine and an intake passage enabling air to enter the cylinder prior to combustion.

The first and second outlet passages are provided with a first and second exhaust valve 19, 19a respectively. The first outlet passage is linked to a first manifold 5 while the second outlet passage is linked to a second manifold 7.

The exhaust system then comprises a first said exhaust pipe 4 through the turbine leading from the first exhaust manifold 5 and a second so-called discharge pipe 6 leading from the second exhaust manifold 7 for the removal of the gases resulting from the combustion in the engine during an exhaust phase. The turbine 2 has a main expansion passage, not shown in the Figures, that houses a turbine impeller. The first pipe 4 opens into the main expansion passage on entering the turbine 2.

According to the invention, as shown in the embodiment in FIG. 2, the first outlet passage of said at least one cylinder is provided with active means 20 to keep closed during the engine's exhaust phase and the second pipe 6 opens into the turbine 2 in at least one bypass portion 8 inside the turbine 2 bypassing the main expansion passage.

Outside the exhaust phase, the first and second outlet passages are closed by their associated exhaust valve 19, 19a. During the exhaust phase, the means to keep closed 20 for the three first passages shown in FIG. 2 of the three cylinders allow this closure to be maintained while the associated first exhaust valves 19 should be open.

In a preferred embodiment, it is the two outlet passages of the cylinder or of each cylinder of the engine that can be selectively closed during the exhaust phase from the engine of the gases resulting from combustion. In this embodiment, the second outlet passage of said at least one cylinder is provided with active means 20a to keep closed during the engine's exhaust phase, the closing means 20, 20a of one of the outlet passages being independent of the closing means 20a, 20 of the other one of the two outlet passages of said at least one cylinder.

In the preferred embodiment of the means to keep closed 20, 20a, the closing means 20, 20a are the means of keeping the associated exhaust valve 19, 19a in a deactivated position in which the exhaust valve 19, 19a shuts off its associated outlet passage of said at least one cylinder during the exhaust phase.

The first exhaust valve 19 associated with the first outlet passage for each cylinder is therefore kept closed by being deactivated whereas it should open during the exhaust phase. This applies to the second exhaust valve 19a when means 20a to keep closed are also provided for the second outlet passage of each cylinder.

The closing means 20, 20a can be in the form of a cam displacement system with a removable tappet or removable follower, the tappet or follower being associated with a hydraulic or electrical control, or in the form of an electromagnetic valve or a pneumatic valve.

As shown in FIG. 2, the extensions of the first and second pipes 4, 6 into the turbine that are the main expansion passage and said at least one bypass portion 8 respectively open into the turbine 2 downstream of the impeller, said at least one bypass portion 8 bypassing the turbine 2 by means of at least one respective outlet end 8b. This occurs towards the outlet of the turbine.

Advantageously, the turbine 2 comprises a casing 2c that surrounds it with one inlet face 2a and one outlet face 2b. The first and second pipes 4, 6 open onto the inlet face 2a of the turbine while being extended respectively by the main expansion passage and said at least one bypass portion 8. On the outlet face 2b of the casing 2c of the turbine 2, outside the turbine, is provided a third duct 9 removing the exhaust gases from the turbine 2.

Advantageously, the engine assembly 1 comprises an exhaust gas recirculation line that branches off one of the first and second pipes 4, 6 or off one of their extensions inside the turbine. In FIG. 2, this branch point is made through the turbine 2 preferably on said at least one bypass portion 8 extending the second duct 6 inside the turbine 2.

Advantageously, the third duct 9 comprises decontamination elements 10 for the exhaust gases passing through it. These decontamination elements 10 can benefit from the first passages of the cylinder being kept closed, with no flow passing through the first duct 4. In this case the flow arriving in the decontamination elements 10 comes exclusively from the second duct 6 via the bypass portion 8. Since the bypass portion 8 of the second duct 6 bypasses the impeller of the turbine 2 and does not exchange energy therewith, the incoming exhaust gases it contains are hotter than the exhaust gases passing through the main expansion passage extending the first duct 4. Consequently, the decontamination elements 10 are passed through by hotter gases than when the first outlet passages are open, which favors the increase in temperature of the exhaust gases arriving in the decontamination elements.

Referring to FIGS. 2 to 5, the present invention also relates to a method of control of an exhaust of an internal combustion engine assembly 1 having a turbocharger comprising a turbine 2 and a compressor 3 and an exhaust system. The engine comprises at least one cylinder housing a piston linked to a rotating crankshaft and mobile inside said at least one cylinder between a most internal position, called Top Dead Center, and a least internal position, called Bottom Dead Center.

Said at least one cylinder has first and second outlet passages opening into the exhaust system for a removal of the exhaust gases resulting from the combustion in the engine and one intake passage for the admission of air into the cylinder before combustion.

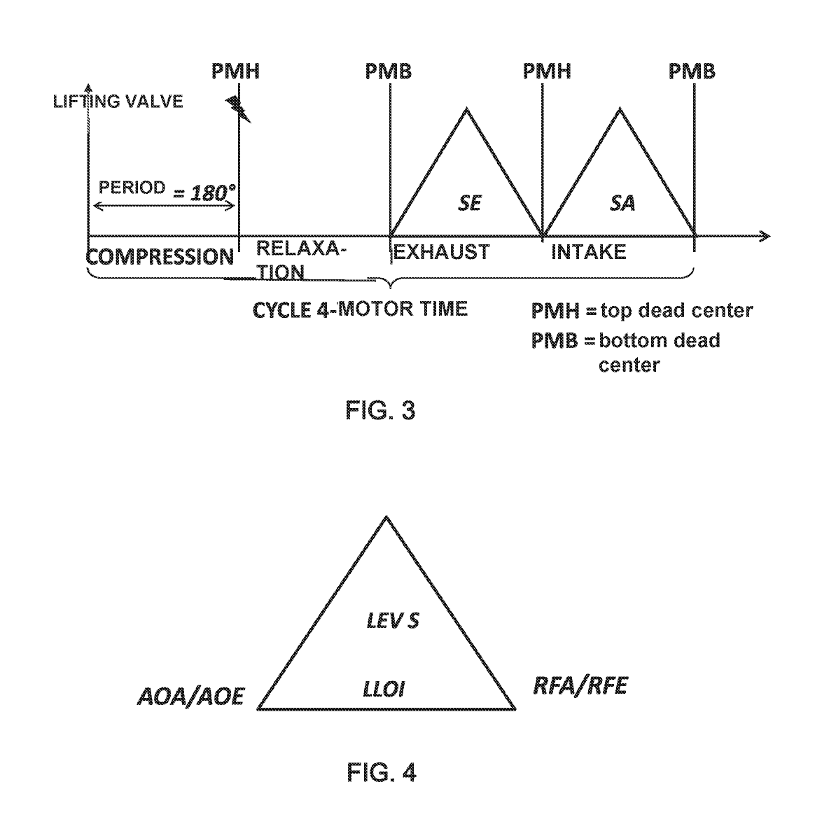

FIG. 3, while referring to FIG. 2 for references 19, 19a, shows the succession of phases over one cycle of a four-stroke engine with phases of compression, expansion, exhaust and intake. Each of the two outlet passages per cylinder is provided with an exhaust valve 19, 19a and the intake passage is provided with an intake valve.

In a conventional way, the exhaust valves 19, 19a open their passage between Bottom Dead Center BDC and Top Dead Center TDC during an exhaust phase and the intake valve opens its passage between Top Dead Center TDC and Bottom Dead Center BDC with, for each valve, a predetermined opening advance and closing delay in relation to said Dead Centers TDC and BDC.

Referring to FIGS. 2 and 4, FIG. 4 shows a valve lift VAL L, which is the distance between the base of the triangle and its highest extremity, the valve lift law LLAW being the width of the base of the triangle and symbolizing the valve opening time. The triangle shape means that the opening and closing of a valve are not instantaneous but gradual over a transient period of time between, on the one hand, the start of opening and complete opening of the valve and, on the other, the start of closing and the complete closing of the valve.

Since the intake of air into each cylinder and the opening of the intake valve are not instantaneous, it is advantageous to start to open the intake valve slightly before reaching Top Dead Center. This results in an intake opening advance IOA. Similarly, the intake valve remains open slightly longer after Top Dead Center, which gives the intake closing delay or ICD.

Depending on the operating point of the engine, there will be a tendency to control both the intake opening advance IOA for maximum filling and engine power and the intake closing delay ICD for reducing engine pumping at low load. The distance between the intake opening advance IOA and intake closing delay ICD often exceeds 180°, apart from the fact that the openings and closings are not instantaneous. In a more simplistic way, the intake closing delay ICD is the consequence of the choice of the intake opening advance IOA position and of the total width of the law, which is the valve opening time often exceeding 180° for intake valves, being 210° for example for some three-cylinder engines. It should be noted that the triangle diagrams falling to 180° are provided merely to simplify the illustration and are not limiting.

The same applies to the two exhaust valves with an exhaust opening advance EOA and an exhaust closing delay ECD respectively. In fact, each exhaust valve is open slightly before Bottom Dead Center with an exhaust opening advance EOA. It is likewise for the exhaust closing delay ECD in relation to Top Dead Center.

The exhaust has two exhaust gas flows exiting the engine. A first exhaust flow comes from the first outlet passage of said at least one cylinder and passes through the turbine 2 via an impeller for the partial recovery of an energy contained in the exhaust gases passing through it inside the turbine 2. A second so-called discharge flow coming from the second outlet passage through the cylinder joins the first flow downstream of the impeller while bypassing the latter.

With reference to all of the Figures except for FIG. 1, according to the method of the present invention, at least the first flow is temporarily interrupted in the exhaust system when a minimum temperature of the exhaust gases is required or when the operating conditions of the engine cause a risk of pumping of the turbocharger, suspensive operating conditions of the interruption of the first flow being an increase in an engine load requiring a use of the turbocharger with an air intake pressure higher than atmospheric pressure. Moreover, while keeping the first outlet passage closed, during the exhaust phase, at least the opening advance EOA of the second exhaust valve 19a and the opening advance of the intake valve IOA of said at least one cylinder are modified.

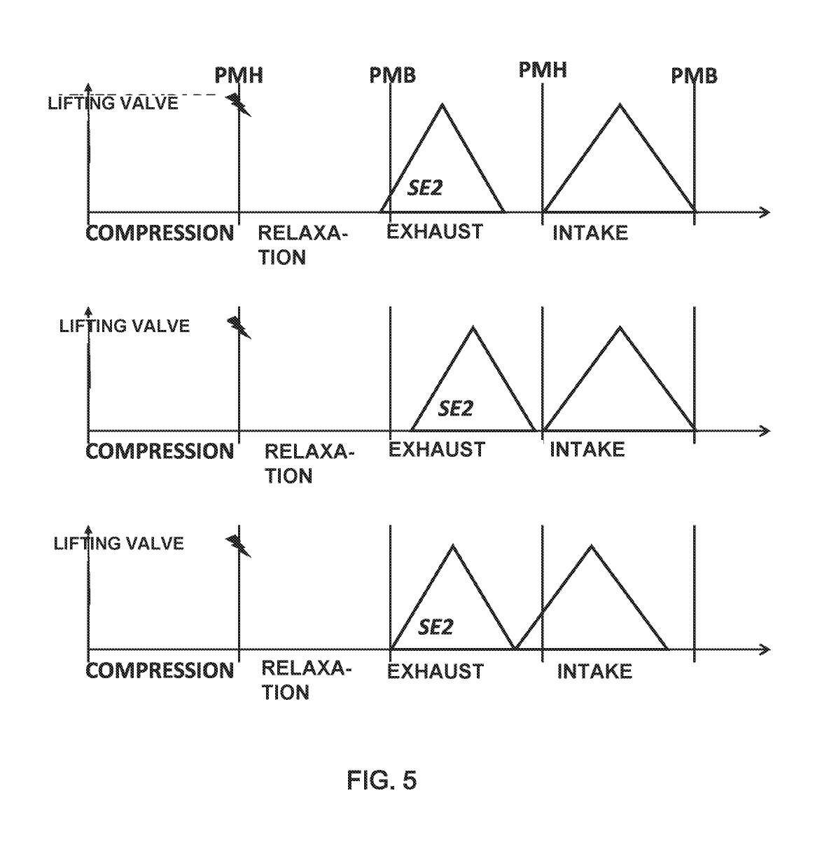

This will be better understood with regard to FIG. 5, while referring to FIG. 4. FIG. 5 shows three specific cases that could occur while keeping the first outlet passage of said at least one cylinder closed. The present invention proposes modifying the opening advance of the second valve 19a and the opening advance of the intake valve of said at least one cylinder.

The opening time of the second exhaust valve, referenced LLAW in FIG. 4, has consequences for the proper operation of the control method according to the invention.

If this opening time is short, being for example less than 180° crank angle, the crank angle being shown in the abscissa of the curves of FIG. 5, and if the closing delay of the exhaust valve ECD is equal to or above the Top Dead Center position of the engine, the recompression of exhaust gases during the start of the exhaust phase of a four-stroke engine cycle will be generated with an increase in engine pumping losses. This is illustrated by the specific case shown at the top of FIG. 5.

In the specific case shown beneath the first case in FIG. 5, while referring to FIG. 4 for some of the references, if the exhaust valve opening advance EOA is equal to or above the Bottom Dead Center BDC position and if the intake valve opening advance IOA is equal to or below the Top Dead Center position TDC of the engine, the recompression of the exhaust gases during the end of the exhaust phase of a four-stroke engine cycle will also be generated, which will cause an increase in engine pumping losses.

Referring to FIGS. 2 to 5, the following case is the case corresponding to the adjustment proposed by the present invention. In order to overcome these pumping problems, the exhaust valve opening advance position EOA of the second exhaust valve is adjusted to a position at least equal to or above the Bottom Dead Center BDC position, thus after combustion. This adjustment is combined with an adjustment of the intake valve opening advance IOA position at least equal to or above, in the latter case with a valve overlap between the intake valve and the second exhaust valve, the closing delay position of the second exhaust valve ECD. This combination of adjustments is made whilst ensuring that the opening time of the second exhaust valve or valve law is not too short, being ideally greater than 140° crank angle.

According to an embodiment of the method according to the invention, the first outlet passage is kept closed by closing means 20 during the exhaust phase in operating conditions after engine start-up or at low engine speed with an engine load corresponding to an engine air intake pressure below atmospheric pressure.

For a closure of the first passage or second passage for each engine cylinder or their reopening, the engine's operating conditions are evaluated by monitoring at least one engine operating parameter, said at least one operating parameter being selected from the following parameters considered individually or in combination: engine speed, time elapsed after start-up, exhaust gas temperature, engine temperature, one or more parameters representative of the engine load such as an air intake pressure at the engine's inlet or a demand for power issued by the vehicle's driver.

To interrupt the first flow, the operating conditions can, for example, be an engine speed and an engine load respectively below a reference engine speed and load and to reopen it, the operating conditions can be, for example, an engine speed and an engine load respectively greater than the reference engine speed and load.

This is motivated by the fact that at low engine speed and load, the operation of the compressor 3 does not require much energy and so the impeller of the turbine 2 has no need to recover energy from the exhaust gases present in the main expansion passage extending the first so-called exhaust duct through the turbine. Thus, there is a possibility of making the flow zero or at least to reduce the flow of exhaust gases in the first duct 4, by closing the first passage of each cylinder, should the need arise, for example but not limited to when there is an advantage to having hotter exhaust gases in the exhaust system.

By contrast, this is no longer the case in the event of a power demand of the engine that requires a higher compression performed by the compressor 3: the first passage of each cylinder is then reopened at least partially depending on the power demand issued.

To sum up, the deactivation zone of the first exhaust duct 4 via the turbine by closing the first passage of each cylinder therefore concerns low engine speeds and loads corresponding to a plenum pressure demanded of the engine control below atmospheric pressure. Above this operating zone, the engine performance, without operation of the turbocharger, can no longer satisfy the power demand issued by the driver. The at least partial reopening of the first passage of each cylinder for the supply of the first duct 4 with exhaust gas is therefore then necessary.

In this case, the first flow is interrupted when the engine speed and one or several parameters representative of the engine load are below the respective predetermined values not requiring the use of the turbocharger, the interruption of the first flow ceasing when one or several parameters representative of the engine load monitored in order to assess the suspensive operating conditions indicate a need for the operation of the turbocharger with a required engine air intake pressure higher than atmospheric pressure.

An example of temporary interruption of the second flow passing through the second duct 6 will be described below. As previously described, the engine outlet comprises per cylinder, at least one cylinder equipping the engine and advantageously three, first and second outlet passages closed by a respective exhaust valve 19, 19a. A series of first outlet passages of the cylinders supplies the first so-called exhaust duct 4 through the turbine and a series of second outlet passages supplies the second so-called discharge duct 6.

According to another embodiment of the invention, a decontamination treatment of the exhaust gases of the first and second flows will be performed after both flows join together, said treatment requiring a minimum decontamination treatment temperature for its operation. In this case, the first outlet passage is kept closed until said minimum temperature is reached and the engine air intake pressure exceeds atmospheric pressure.

The first flow is then advantageously interrupted in conditions after engine start-up in which the prevailing temperature values of the exhaust gases at the end of the exhaust system are detected as being below or estimated to be below a predetermined exhaust gas temperature value. The operating parameters monitored are the detected exhaust gas temperature or engine temperature and the average engine speed over a time elapsed after start-up for an estimation of the exhaust gas temperature.

The interruption of the first flow ceases when the detected or estimated exhaust gas temperature exceeds the predetermined exhaust gas temperature or when one or several parameters representative of the engine load monitored in order to evaluate the suspensive operating conditions indicate a need for operation of the turbocharger with a required engine air intake pressure value higher than atmospheric pressure.

Thus, an engine control supervising the operation of the engine assembly may require an engine intake pressure value higher than atmospheric pressure, for example following a power demand issued by the vehicle's driver, which requires the operation of the turbocharger's compressor.

In this third embodiment, the first flow passing through the first duct 4 with exhaust gases that will lose a great deal of heat while passing through the impeller of the turbine 2 is interrupted by the closure of the first passage by closure means 20 until said minimum temperature is reached. For example, without limitation, the minimum temperature can be between 150° C. and 200° C.

The at least partial deactivation of the first exhaust duct 4 through the turbine improves the heating time of the decontamination elements 10, specifically a catalytic converter, because the expansion of the exhaust gases in the turbine no longer occurs. The decontamination elements 10 are thus passed through by hotter gases, mainly originating from the second duct 6, and rise more rapidly in temperature.

As a result, the decontamination elements 10 reach their activation temperature more quickly. This is particularly advantageous as regards ever-stricter pollutant emission regulations. There is also a potential economic gain with fewer precious metals in the catalytic converter while remaining at the same overall efficiency of decontamination treatment.

In all of these embodiments with interruption of flow, it is preferably the engine control that governs the at least partial opening and closing of the means for keeping the first and, if necessary, the second outlet passage closed, the engine control benefiting moreover from the prevailing engine operating conditions that are compared to the first and second predetermined operating conditions. This is valid for all of the methods of keeping the first or second outlet passage closed.

An EGR line 11 may have a branch point on one or both exhaust ducts in order to draw off some of the exhaust gases in this duct as well as a cooler 23 for the exhaust gases passing through this line 11, these gases then being very hot. This branch point can be made through the turbine 2 as shown in FIG. 2 but this is not compulsory.

The engine assembly 1 comprises an internal combustion engine, a turbocharger comprising a turbine 2 and a compressor 3, and an exhaust system connected to an engine outlet for a removal of the exhaust gases resulting from the combustion in the engine.

The engine comprises at least one cylinder having two outlet passages for a removal of the exhaust gases resulting from the combustion in the engine, the first outlet passage being linked to a first manifold 5 while the second outlet passage is linked to a second manifold 7 for a removal of the exhaust gases resulting from the combustion in the engine. Exhaust valves 19, 19 are provided for the first and second passage respectively.

The exhaust system comprises a first so-called exhaust duct 4 through the turbine 2 leading from the first exhaust manifold 5 and a second so-called discharge duct 6 leading from the second exhaust manifold 7. The first and second manifolds 5, 7 are linked to the outlet of the internal combustion engine in order to channel the exhaust gases through the first and second ducts 4, 6.

The turbine 2 is provided with a casing 2c containing a main expansion passage in which is housed a turbine impeller and the first duct 4 opens into the main expansion passage through an inlet face 2a of the casing 2c, the second duct 6 bypassing the impeller of the turbine 2.

According to the invention, as shown in the two embodiments in FIGS. 1a and 2, the exhaust system of the engine assembly 1 comprises interruption means 16, 17 of the flow of exhaust gas in the first and second ducts 4, 6, the flow interruption means 16, 17 of one of the two ducts 4, 6 being independent of the flow interruption means 16, 17 of the other one of the two ducts 6, 4.

This is valid for both of the embodiments shown in FIGS. 1a and 2 respectively. The interruption is thus made in the exhaust system and in a simple manner without having to change the engine outlet parameters and specifically the activation or deactivation of the exhaust valves 19, 19a.

Advantageously, the flow interruption means 16, 17 are in the form of a regulation valve 16, 17 associated with the respective first or second duct 4, 6 in the exhaust system.

The present invention also concerns a method of control of an exhaust of a valve event modulated boost internal combustion engine assembly 1. Such an engine assembly 1 has a turbocharger comprising a turbine 2 and a compressor 3, the exhaust having two exhaust gas flows with one engine outlet, a first so-called exhaust flow passing through the turbine 2 housing an impeller for the partial recovery of an energy contained in the exhaust gases passing through it, a second flow joining the first flow downstream of the impeller while bypassing the latter.

According to the method of the present invention, the two flows are selectively interrupted temporarily. The interruption can equally well be carried out directly at the engine outlet as further downstream of the engine on ducts 4, 6 and if necessary on their respective extensions in the turbine 2.

The first flow is interrupted in the exhaust system when a minimum temperature of the exhaust gases is required, when the operating conditions of the vehicle do not require the use of the turbocharger with an air intake pressure below or equal to atmospheric pressure or when the operating conditions of the engine cause a risk of pumping of the turbocharger, suspensive operating conditions of the interruption of the first flow being an increase of an engine load requiring a use of the turbocharger with a required air intake pressure higher than atmospheric pressure.

The second flow is interrupted in the event of an increase in an engine load requiring a use of the turbocharger with a required air intake pressure higher than atmospheric pressure. Suspensive operating conditions of the interruption of the second flow can be a risk of pumping of the turbocharger, the operating conditions of the engine being evaluated by monitoring at least one engine operating parameter.

In both cases, said at least one operating parameter is selected from the said at least one operating parameter being selected from the following parameters considered individually or in combination: engine speed, time elapsed after start-up, exhaust gas temperature, engine temperature, one or more parameters representative of the engine load such as an air intake pressure at the engine's inlet or a demand for power issued by the vehicle's driver.

The operating conditions requiring a use of the turbocharger or causing a risk of pumping of the turbocharger are unique to each vehicle. In general, the use of the turbocharger is necessary in the event of a demand for engine power by the driver, which causes an increase in engine load.

It is possible to combine several embodiments of the method. For example, without limitation, on start-up, the first flow can be temporarily interrupted with regard to the first operating condition of the engine assembly, then reestablished. Then the two flows might not be interrupted or only the second flow might be interrupted temporarily taking into account second operating conditions of the engine assembly that differ from the first conditions.

According to a first embodiment of the method according to the invention, the first flow is interrupted in conditions after engine start-up in which the prevailing temperature values of the exhaust gases at the end of the exhaust system are below or estimated to be below a predetermined exhaust gas temperature having as monitored operating parameters the detected exhaust gas temperature value or the engine temperature and the average engine speed over a time elapsed after start-up for an estimation of the exhaust gas temperature.

The first operating parameter is the exhaust gas temperature at the end of the exhaust system where the decontamination elements are located or an estimation of this exhaust gas temperature. As an operating parameter, it is therefore possible to measure the exhaust gas temperature directly or to estimate it on the basis of the engine temperature, since a correlation exists between these two temperatures.

It is also possible to estimate the exhaust gas temperature on the basis of the average of the engine speeds since start-up and of the operating time of the vehicle since start-up, since an estimation of the exhaust gas temperature can be deduced from these parameters.

The interruption of the first flow ceases when one or more of the parameters representative of the engine load monitored in order to evaluate the suspensive operating conditions indicate a need for operation of the turbocharger with a required engine air intake pressure value higher than atmospheric pressure. Obtaining such an engine air intake pressure involves the operation of the turbocharger and therefore a reestablishment of the passage of the first flow through the turbine and its energy-recovery impeller.

One particularly advantageous application of an interruption of the first flow takes place when a treatment is carried out for the decontamination of the exhaust gases of the first and second flows after the first flow is joined by the second flow, said treatment requiring a minimum exhaust gas decontamination treatment temperature for its operation. In this case, the minimum exhaust gas decontamination treatment temperature serves as a predetermined exhaust gas temperature value for the interruption of the first flow.

Another embodiment for which an interruption of the first flow is advantageous is when the engine speed and one or more of the parameters representative of the engine load are below the predetermined respective values not requiring the use of the turbocharger, with a required engine air intake pressure value below or equal to atmospheric pressure.

The interruption of the first flow ceases when one or more of the parameters representative of the engine load and monitored in order to evaluate the suspensive operating conditions indicate a need for operation of the turbocharger with a required engine air take pressure value higher than atmospheric pressure.

In this embodiment, the prevailing engine speed and load values for an interruption of the first flow can be respectively below a predetermined engine speed reference value and a predetermined engine load reference value that do not require the use of the turbocharger and that are unique to each vehicle's engine.

By contrast, a required engine air intake pressure higher than atmospheric pressure is an indicator of a need to use the turbocharger resulting in a reestablishment of the first flow for this condition. This is also the case with an increase in engine speed and engine load higher than the predetermined reference values of engine speed and load respectively.

This is due to the fact that at low engine speed and engine load compared to the respective predetermined reference values of engine speed and engine load, the operation of the compressor 3 requires no or very little energy and that therefore the impeller of the turbine 2 does not need to recover energy from the exhaust gases present in the main expansion passage extending the first so-called exhaust duct 4 through the turbine 2.

It therefore becomes possible to make the flow zero or at least reduce the flow of exhaust gases in the first duct 4, by means of the regulation valve 16, should the need arise, for example but without limitation to when there is an advantage to having hotter exhaust gases in the exhaust system.

By contrast, this is no longer the case in the event of a demand for engine power that requires a higher compression performed by the compressor 3: the regulation valve 16 of the first duct 4 is then reopened at least partially depending on the power demand issued so that the required engine air intake pressure is higher than atmospheric pressure.

To sum up, the deactivation zone of the first exhaust duct 4 through the turbine via its associated regulation valve 16 through which passes the first flow therefore concerns low engine speeds and loads corresponding to a plenum pressure demanded by the engine control below atmospheric pressure. Above this operating zone, engine performance, without operation of the turbocharger, can no longer meet the power demand issued by the driver. The at least partial reopening of the regulation valve 16 in the first duct 4 is therefore necessary.

According to another embodiment of the method according to the invention that can be combined with the embodiments previously mentioned not concerning the same flow, with different engine operating moments being staggered over time, the second flow passing through the second so-called discharge duct 6 then through its extension in the turbine 2 via said at least one bypass portion 8 is interrupted. At least two cases can then arise.

In the first case of interruption of the second flow, the engine speed is lower than a predetermined speed value and one or more parameters representative of the engine load are higher than a predetermined engine load value. In this case, there may be two parameters to be considered, namely a parameter representative of the engine load and a parameter representative of the engine speed. The second case of interruption of the second flow occurs at transient engine speeds with one or more parameters representative of engine load higher than a predetermined engine load value. The predetermined engine load value in both cases is that which requires the use of the turbocharger for the engine concerned.

This is due to the fact that at high engine load, the operation of the compressor 3 requires a great deal of energy and that the impeller of the turbine 2 must therefore recover as much energy as possible from the exhaust gases present in the main expansion passage extending into the turbine 2 the first so-called exhaust duct 4 through the turbine, which makes it necessary to make the flow greater in the first duct 4 and its associated passage.

This can be achieved by a complete or partial closure of the regulation valve 17 located in the second duct 6, making the flow of gases in the second duct 6 zero or greatly reducing it and consequently in said at least one bypass portion 8 that extends it. By contrast, this is no longer the case in the event of a demand for engine power that no longer requires a high compression performed by the compressor 3: the regulation valve 17 of the second duct 6 is then reopened at least partially depending on the drop in the power demand issued.

Another example of temporary interruption of the second flow passing through the second duct 6 will be described below. As previously described, the engine outlet comprises for each cylinder, at least one cylinder equipping the engine and preferably three, first and second outlet passages closed by a respective exhaust valve 19, 19a, as shown in FIGS. 1a and 2. A series of first outlet passages of the cylinders supplies the first so-called exhaust duct 4 through the turbine and a series of second outlet passages supplies the second so-called discharge duct 6. The exhaust valves 19, 19a are provided with activation mechanisms 20, 20a.

However, on each cylinder, the opening of the exhaust valve 19a linked indirectly to the second duct 6 very often occurs after the opening of the exhaust valve 19 of the same cylinder linked to the first duct 4 and always during the exhaust phase of the engine's four-stroke cycle, even on the most delayed timing of the opening of the exhaust valve 19a linked to the second duct 6.

A period of time therefore elapses during which both exhaust valves 19, 19a are open at the same time, which means that the second discharge duct 6 is always operational, although this can be unfavorable in certain operating conditions of the engine assembly 1.

According to an embodiment of the invention, it is possible to interrupt the flow in the second duct 6 selectively so that the second duct 6 is not permanently always open, particularly when there is a demand for power of the engine assembly.

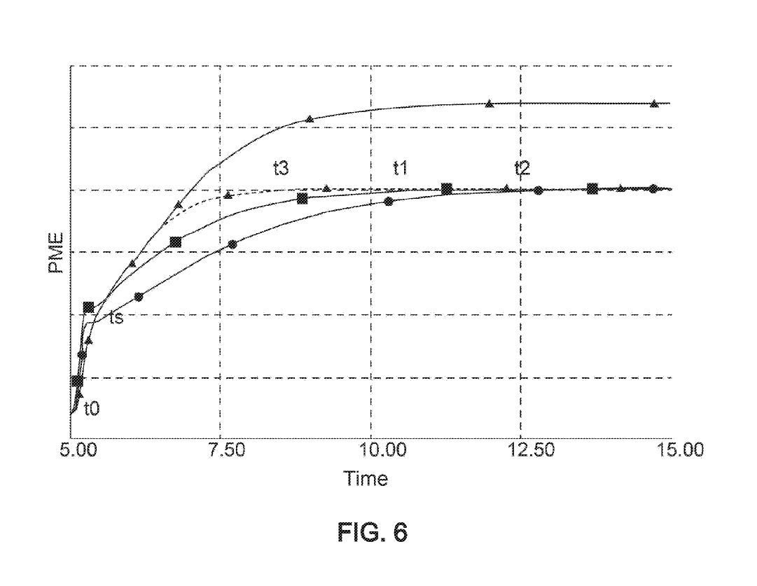

FIG. 6 shows three curves as a function of time of the mean effective pressure or MEP, which is an indicator of the performance of a combustion engine. The mean effective pressure is the relationship between the work provided by the engine during a cycle and the cubic capacity of an engine. The mean effective pressure allows the engine load to be calculated.

The first curve in the middle illustrated by squares is the reference curve corresponding to a conventional turbocharged engine assembly. The second curve at the bottom illustrated by circles is the curve corresponding to a valve event modulated boost engine assembly not provided with interruption means according to the present invention and the third curve at the top illustrated by triangles relates to a valve event modulated boost engine assembly provided with flow-interruption means according to the present invention.

These curves represent the times t0, ts, t3, t1 and t2 which correspond respectively to start-up in transient phase starting at an initial torque value and start-up of the supercharging phase, the final three times corresponding to a target torque waiting time.

Between time t0 of start-up in transient phase and ts of start-up in supercharged phase, engine performance is given by the natural filling of the engine without recourse to supercharging, whether the conventional supercharged engine assembly or the valve event modulated boost engine assembly.

Between time ts and times t1, t2, t3, which are the times of reaching a torque target, an increase in engine torque occurs in supercharged mode, which is the engine's instant torque. This shows the capacity of the turbocharger to supply power, by compressing the intake air, the waiting time being longer when the compression of the intake air is low.

In the case of the curve of a valve event modulated boost engine assembly not equipped with interruption means, as the turbine receives less exhaust gas flow due to the opening of the second duct, the increase in torque is slower.

In the case of the curve relating to a valve event modulated boost engine assembly provided with flow interruption means according to the present invention, the increase in torque is at least as good as that of a reference turbocharged engine assembly. In FIG. 6, it is even higher, because in the case of the engine assembly according to the invention, the size of the exhaust manifold is smaller than in the reference case with fewer passages associated with the exhaust valves connected to the same volume.

Now a small manifold favors engine performance at low speed because, with its smaller volume, the expansion of the exhaust gases before passing through the turbine is less. The enthalpy of the gases is therefore slightly greater than that of the reference engine assembly, resulting in the gain in performance shown by a steeper slope of the curve.

During an increase in engine load:
a) Between t0 and ts: if the engine torque before the start of the transient phase is between the torque values of this zone, the flow in the second duct is not at least partially interrupted,
b) Around ts: when the torque approaches the maximum torque without the contribution of the turbocharger, it is possible to anticipate the occurrence of the opening delay of the exhaust valves and their outlet passages associated with the second duct in order to prepare the activation of the turbine and have a smoother t0-ts-t3 transition,
c) Between ts and around t3: the second duct is kept with an opening delay, this delayed opening being generated by the associated interruption means until approaching the target torque. On reaching between 75% and 90% of the torque setpoint value, it is possible to reopen the second duct by widening the opening law of the interruption means in dynamic mode or even by exiting dynamic control mode of the interruption means in order to avoid exceeding the setpoint torque target.

If the second duct is still kept with an opening delay, via the interruption means, after ts it is possible to benefit from a stimulation function of the engine assembly because in this condition more engine torque compared to the reference case can be generated. However, this type of action should be used on a temporary basis because, at low speed and high torque, increased pinking is likely to occur, which damages the engine. The maximum torque of the reference engine assembly constitutes the absolute safety reference.

The interruption means can also keep the second discharge duct partially closed. In this case, a modulation function of the flow of gas conveyed to the turbine is performed while obtaining a discharge flow via the second duct in order to continue to optimize pumping losses.

The escape of gas via the second duct is thus always managed efficiently but the gains will be smaller compared to a situation where the interruption means are fully open and thus inoperative. What is sought after in that specific case is to be able to modulate the torque increase curve after is as desired by the driver, therefore with an additional degree of freedom.

Referring generally to all of the Figures, the at least partial interruption of the flow of exhaust gas in the second duct 6 allows an improvement in the power recovered by the turbine 2 because all or almost all of the engine flow passes through the impeller of the turbine 2 via the first duct 6 and its main expansion passage extending it into the turbine. This interruption will be effective over all of the engine's phases of life corresponding to those where a discharge valve of a conventional turbocharged engine is closed, in other words basically at full load and low engine speed and during high load transient phases.

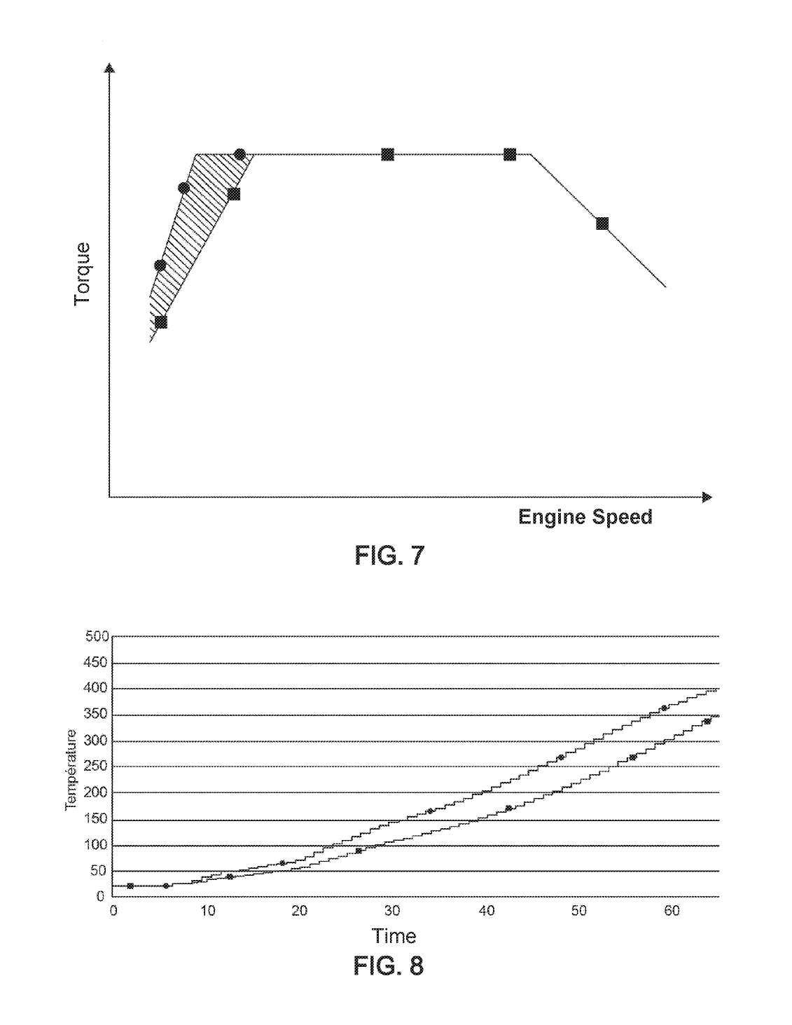

FIG. 7 shows engine torque as a function of engine speed, the hatched area shows the increase in torque achieved by deactivation of the second duct via the interruption means, during full load low speed operation of the engine assembly, as shown by the curve with circles compared to the curve with squares, which is that obtained without interruption. This increase in torque is considerable.

Referring to all of the Figures except for FIG. 1, according to a third embodiment of the invention substantially close to the first mode being a particular application of this first mode, as previously mentioned, a treatment for the decontamination of the exhaust gases of the first and second flows can be performed after the first flow is joined by the second flow, said treatment requiring a minimum decontamination treatment temperature for its operation.

In this case, the first flow passing through the first duct 4 with exhaust gases that will lose a great deal of heat while passing through the impeller of the turbine 2 is interrupted by the regulation valve 16 until said minimum temperature is reached. For example, without limitation, the minimum temperature can be between 150° C. and 200° C.

The at least partial deactivation of the first exhaust duct 4 through the turbine improves the heating time of the decontamination elements 10, specifically a catalytic converter, because the expansion of the exhaust gases in the turbine no longer occurs. The decontamination elements 10 are thus passed through by hotter gases, mainly originating from the second duct 6 and rise more rapidly in temperature.

This is shown in FIG. 8, the top curve with circles corresponds to a deactivation of the first duct 4 while the bottom curve with squares corresponds to a valve event modulated boost engine assembly without regulation of flow in the first duct 4. The decontamination elements 10 reach their activation temperature more rapidly. This is particularly advantageous as regards ever-stricter pollutant emission regulations. There is also a potential economic gain with fewer precious metals in the catalytic converter while remaining at the same overall efficiency of decontamination treatment.

It is preferably the engine control that governs the at least partial opening and closing of the two regulation valves 16, 17, the engine control benefitting moreover from the prevailing engine operating conditions that are compared to the predetermined operating conditions. This is valid for all of the methods of flow interruption, whether the first or the second flow.

Preferably, each valve 16, 17 is a control valve of the type turbocharger discharge valve, throttle valve, engine valve, with a diaphragm or ball, this valve 16, 17 being operated by its own specific electrical, pneumatic or hydraulic actuator.

FIG. 1a shows an engine assembly 1 equivalent to that shown in FIG. 1 to illustrate the state of the art with, however, the significant difference that the engine assembly comprises interruption means 16, 17 of the flow of exhaust gas in the first and second ducts 4, 6. As for FIG. 2, it shows a preferred embodiment of the exhaust system of the engine assembly according to the present invention. These two embodiments form part of the present invention.

In the latter embodiment, the second discharge duct 6 opens into an inlet face 2a of the casing 2c of the turbine and at least one bypass portion 8 is extended into the turbine 2 bypassing the main expansion passage housing the turbine impeller.

Thus, a bypass portion 8 extending the second duct 6 is incorporated into the turbine 2 but is not in kinetic energy exchange with the impeller of the turbine 2, which causes a discharge effect of the turbine 2 even more efficient than the discharge effect obtained with a discharge valve in a conventional state of the art turbocharger.

Moreover, the fact that a bypass portion 8 extending the second duct 6 is incorporated into the turbine 2 reduces the space occupied by the exhaust system and reduces the cost of material for the second duct 6, the joining of the first and second ducts 4, 6 taking place in the turbine 2 and not after the turbine 2, resulting in a shortening of the length of the second duct 6 which need not be of a length enabling it to bypass the turbine 2. This shortening of the second duct 6 as well as housing the bypass portion 8 extending the second duct 6 inside the turbine 2 are favorable to limiting the drop in temperature of the exhaust gases in the second duct 6, specifically by better insulation of the second duct 6.

The main expansion passage and said at least one bypass portion 8 join together at an outlet face 2b of the casing 2c, the outlet end of said at least one bypass portion towards the outlet face 2b of the casing 2 being referenced 8b in FIG. 2. Advantageously, the exhaust system comprises a third duct 9 outside the turbine 2 being linked to the outlet face 2b of the turbine casing 2c for the removal of the exhaust gases from the turbine 2.

Advantageously, when the flow interruption means 16, 17 are in the form of a regulation valve 16, 17, a regulation valve 16, 17 is positioned for each duct 4, 6 either on the exhaust manifold 5, 7 associated with said duct 4, 6 or on or in a casing of the turbine 2 remotely surrounding the impeller.

As shown in FIG. 2, the casing 2c of the turbine 2 can comprise an inlet face 2a of the exhaust gases receiving the first and second ducts 4, 6 and an outlet face 2b of the exhaust gases as well as an intermediate portion linking the faces 2a, 2b together. Although this is not shown in the Figures, the regulation valves can be incorporated in the casing 2c of the turbine 2.

Alternatively, a regulation valve 16, 17 can be positioned on a portion of each duct 4, 6 comprised between its respective exhaust manifold 5, 7 and the turbine 2, which is shown in FIG. 2.

Thus, the regulation valve 16, 17 can be positioned between the exhaust manifold 5, 7 of its respective duct 4, 6 and the turbine 2. The inlet face 2a of the turbine 2, which is the face of the turbine 2 opposite the exhaust manifolds 5, 7 can comprise a flange. When this flange is fixed to a flange equipping each exhaust manifold 5, 7, the regulation valve 16, 17 of each of the first and second ducts 4, 6 is positioned between the flange of the respective exhaust manifold 5, 7 and the flange of the turbine 2.

An EGR line 11 may have a branch point on one or both exhaust ducts in order to draw off some of the exhaust gases in this duct as well as a cooler 23 for the exhaust gases passing through this line 11, these gases then being very hot. This branch point can be made through the turbine 2 as shown in FIG. 2 but this is not compulsory.

1. A method to control an exhaust of an internal combustion engine assembly of a motor vehicle having a turbocharger comprising: a turbine, a compressor, and an exhaust system, the engine having at least one cylinder housing a piston linked to a rotating crankshaft and movable inside said at least one cylinder between a most internal position called Top Dead Center and a least internal position called Bottom Dead Center, said at least one cylinder having a first and second outlet passage opening into the exhaust system for a removal of the exhaust gases resulting from the combustion in the engine and an intake passage, the first and second outlet passage being equipped respectively with a first and a second exhaust valve and the intake passage being equipped with an intake valve, the exhaust valves opening their passage between Bottom Dead Center (and Top Dead Center during an exhaust phase and the intake valve opening its passage between Top Dead Center and Bottom Dead Center according to an angle of rotation of the crankshaft with, for each valve, a predetermined opening advance and closing delay (ECD) in relation to said Dead Centers, the exhaust having two gas exhaust flows exiting the engine, a first exhaust flow coming from the first outlet passage of said at least one cylinder passing through the turbine housing an impeller for the partial recovery of an energy contained in the exhaust gases inside the turbine and a second so-called discharge flow coming from the second outlet passage joining the first flow downstream of the impeller while bypassing it, such that at least the first flow is interrupted temporarily in the exhaust system when a minimum temperature of the exhaust gases is required or when the operating conditions of the engine bring about a turbocharger pumping risk, suspensive operating conditions of the interruption of the first flow being an increase in engine load requiring a use of the turbocharger and such that, while keeping the first outlet passage closed, during the exhaust phase, at least the opening advance of the second exhaust valve and the opening advance of the intake valve of said at least one cylinder are modified.

2. The method according to claim 1, wherein the opening advance position of the second exhaust valve of said at least one cylinder dedicated to the second flow is adjusted to a position at least equal to or above Bottom Dead Center in combination with an opening advance position of the intake valve at least equal to or above the closing delay position of the second exhaust valve with a valve width law for the second exhaust valve between the opening advance position of the second exhaust valve and the closing delay of the second exhaust valve which is no less than 140° of the engine's crankshaft angle.

3. The method according to claim 1, wherein the engine's operating conditions are evaluated by monitoring at least one engine operating parameter selected from the following parameters considered individually or in combination: engine speed, time elapsed after start-up, exhaust gas temperature, engine temperature, one or more parameters representative of the engine load such as the air intake pressure at the engine's inlet or a demand for power issued by the vehicle's driver.

4. The method according to claim 1, wherein the interruption of the first flow is performed:
in conditions after engine start-up for which the prevailing temperature values of the exhaust gases at the end of the exhaust system are detected as being below or estimated as being below a predetermined exhaust gas temperature value with the monitored operating parameters being the detected exhaust gas temperature or the engine temperature and the average engine speed over a period elapsed after start-up for an estimation of the exhaust gas temperature, the interruption of the first flow ceasing when the detected or estimated exhaust gas temperature exceeds the predetermined exhaust gas temperature value or when one or more of the parameters representative of the engine load monitored in order to evaluate the suspensive operating conditions indicate a need for the operation of the turbocharger with a required engine air intake pressure value above atmospheric pressure, or
when the engine speed and one or more parameters representative of the engine load are below predetermined respective values not requiring the use of the turbocharger, the interruption of the first flow ceasing when one or more parameters representative of the engine load monitored in order to evaluate the suspensive operating conditions indicate a need for operation of the turbocharger with a required engine air intake pressure value higher than atmospheric pressure.

5. An engine assembly comprising an internal combustion engine with at least one cylinder and a turbocharger comprising a turbine, a compressor, and an exhaust system for implementing the method according claim 1, the engine comprising at least one cylinder having a first and a second outlet passage for a removal of the exhaust gases resulting from the combustion in the engine, the first and second outlet passages being provided respectively with a first and a second exhaust valve, the first outlet passage being linked to a first manifold while the second outlet passage is linked to a second manifold, the exhaust system comprising a first so-called exhaust duct through the turbine leading from the first exhaust manifold and a second so-called discharge duct leading from the second exhaust manifold for the removal of the gases resulting from the combustion in the engine during an exhaust phase, the turbine having a main expansion passage in which is housed a turbine impeller, the first duct opening into the main expansion passage of the turbine, characterized in that the first outlet passage of said at least one cylinder is provided with active means to keep closed during the engine's exhaust phase and in that the second duct opens into the turbine in at least one bypass portion inside the turbine bypassing the main expansion passage.

6. The assembly according to claim 5, wherein the second outlet passage of said at least one cylinder is provided with active means to keep closed during the engine's exhaust phase, the closing means of one of the outlet passages being independent of the closing means of the other of the two outlet passages of said at least one cylinder.

7. The assembly according to claim 5, wherein the closing means are means for keeping the associated exhaust valve in a deactivated position in which the exhaust valve blocks its associated outlet passage of said at least one cylinder during the exhaust phase.

8. The assembly according to claim 5, wherein the exhaust system comprises a third duct outside the turbine coming out of the turbine, the third duct removing the exhaust gases from the main expansion passage and from said at least one bypass portion outside the turbine, the third duct comprising decontamination elements for the exhaust gases passing through it.

9. A method to control an internal combustion engine assembly of a motor vehicle, specifically according to claim 1, said engine assembly having a turbocharger comprising a turbine and a compressor, and an exhaust system having two flows of exhaust gases at an outlet of the engine, a first flow passing through the turbine housing an impeller for the partial recovery of an energy contained in the exhaust gases and a second flow joining the first flow downstream of the impeller while bypassing it, characterized in that the two flows are selectively temporarily interrupted, on the one hand, the first flow being interrupted in the exhaust system when a minimum exhaust gas temperature is required or when the engine's operating conditions cause a risk of pumping of the turbocharger, suspensive operating conditions of the interruption of the first flow being an increase of an engine load requiring a use of the turbocharger and, on the other, the second flow being interrupted in the event of an increase of an engine load requiring a use of a turbocharger, suspensive operating conditions of the interruption of the second flow being a risk of pumping of the turbocharger, the engine's operating conditions being evaluated by monitoring at least one engine operating parameter selected from the following parameters considered individually or in combination: engine speed, time elapsed after start-up, exhaust gas temperature, engine temperature, one or more parameters representative of the engine load such as the air intake pressure at the engine's inlet or a demand for power issued by the vehicle's driver.

10. The method according to claim 9, wherein the first flow is interrupted:
in conditions after engine start-up for which the prevailing temperature values of the exhaust gases at the end of the exhaust system are detected as being below or estimated as being below a predetermined exhaust gas temperature value with the monitored operating parameters being the detected exhaust gas temperature or the engine temperature and the average engine speed over a period elapsed after start-up for an estimation of the exhaust gas temperature, the interruption of the first flow ceasing when the detected or estimated exhaust gas temperature exceeds the predetermined exhaust gas temperature value or when one or more of the parameters representative of the engine load monitored in order to evaluate the suspensive operating conditions indicate a need for the operation of the turbocharger with a required engine air intake pressure value above atmospheric pressure, or
when the engine speed and one or more parameters representative of the engine load are below predetermined respective values not requiring the use of the turbocharger with an engine air intake pressure value below or equal to atmospheric pressure, the interruption of the first flow ceasing when one or more parameters representative of the engine load monitored in order to evaluate the suspensive operating conditions indicate a need for operation of the turbocharger with a required engine air intake pressure value higher than atmospheric pressure.

11. The method according to claim 10, wherein a treatment will be implemented to depollute the exhaust gases of the first and second flows after the first flow is joined by the second flow at the end of the exhaust system, said treatment requiring a minimum exhaust gas decontamination treatment temperature in order to operate, said minimum exhaust gas decontamination treatment temperature serving as a predetermined temperature value of the exhaust gases at the end of the exhaust system for the interruption of the first flow.

12. The method according to claim 9, wherein the second flow is interrupted:
when the engine speed is below a predetermined speed value and when one or more of the parameters representative of the engine load exceed a predetermined engine load value, or
for transient engine speeds with one or more parameters representative of the engine load higher than a predetermined engine load value, the predetermined engine load value in both cases requiring the use of the turbocharger with a required engine air intake pressure value higher than atmospheric pressure.

13. An engine assembly comprising an internal combustion engine and a turbocharger comprising a turbine, a compressor, and an exhaust system for implementing such a method according to claim 1, the engine comprising at least one cylinder having two outlet passages for a removal of the exhaust gases resulting from the combustion in the engine, the first outlet passage being linked to a first manifold while the second outlet passage is linked to a second manifold for a removal of the exhaust gases resulting from the combustion in the engine, the exhaust system comprising a first so-called exhaust duct through the turbine leading from the first exhaust manifold and a second so-called discharge duct leading from the second exhaust manifold for channeling the exhaust gases through the first and second ducts of the turbine being provided with a casing having within it a main expansion passage in which is housed a turbine impeller and the first duct opening into the main expansion passage through an inlet face of the casing, the second duct bypassing the impeller of the turbine, characterized in that the system comprises interruption means of the flow of exhaust gas in the first and second ducts, the flow interruption means of one of the two ducts being independent of the flow interruption means of the other one of the two ducts.

14. The assembly according to claim 13, wherein the second duct opens through the inlet face of the casing into at least one bypass portion inside the casing bypassing the main expansion passage, the main expansion passage and said at least one bypass portion joining an outlet face of the casing, the exhaust system comprising a third duct outside the turbine while being linked to the outlet face of the turbine casing in order to remove the exhaust gases from the turbine.

15. The assembly according to claim 13, wherein, when the flow interruption means are in the form of a regulation valve the regulation valve is positioned for each duct either on the exhaust manifold associated with said duct, or in the casing of the turbine on the main expansion passage and, when present, on said at least one bypass portion.
